(19) United States
(12) Patent Application Publication
(10) Pub. No.: US 2025/0139808 A1
(43) Pub. Date: May 1, 2025

(54) SHELF POSITIONING METHOD, SHELF CONNECTING METHOD AND DEVICE, EQUIPMENT AND MEDIUM

(71) Applicant: LINGDONG TECHNOLOGY (BEIJING) CO.LTD., Beijing (CN)

(72) Inventors: Jin CHENG, Beijing (CN); Peng CHENG, Beijing (CN); Ou QI, Beijing (CN)

(21) Appl. No.: 18/690,693

(22) PCT Filed: Sep. 8, 2022
(86) PCT No.: PCT/CN2022/117683

§ 371 Date: Mar. 8, 2024

(30) Foreign Application Priority Data
Sep. 10, 2021 (CN) 202111064188.2

(51) Int. Cl. G06T 7/70; B65G 43/00

(52) U.S. Cl. CPC G06T 7/70; B65G 43/00; G06T 2207/10028

(57) ABSTRACT

The present application provides a shelf positioning method, a shelf connecting method and device, equipment and a medium. The method comprises the following steps: acquiring image data, in the environment where a movable equipment is located, through an image acquisition module in the movable equipment; inputting the image data into a key point detection network to extract first position information of shelf key points in an image coordinate system from the image data through the key point detection network; and determining relative pose of the shelf key points relative to the movable equipment according to the first position information and a conversion relationship between the image coordinate system and a vehicle body coordinate system. In this method, visual semantic features of a shelf are extracted from the image data of the environment where the movable equipment is located through the key point detection network, and the a relative pose of the shelf relative to the movable equipment is determined based on the visual semantic features, which makes the detection of the position of the shelf more accurate, improves the accuracy of shelf positioning, expands the application range of shelf positioning and reduces the hardware cost of shelf positioning.

### TECHNICAL FIELD

The present application relates to the technical field of logistics, in particular to a shelf positioning method, a shelf connecting method and device, equipment and a medium.

### BACKGROUND

Movable equipment is an important part of an automated warehousing and logistics system. In the warehousing and logistics scenario, movable equipment is connected with shelves to move and unload goods to achieve automated scheduling and handling of warehouse goods.

Taking the example of a lifting shelf, before the movable equipment is connected with the lifting shelf, it is necessary to position the lifting shelf. In the related art, light detection and ranging (LiDAR), solid-state radar, red green blue depth (RGBD) cameras and other devices are usually used to collect depth information of the lifting shelf, and then position the insertable side of the lifting shelf based on the depth information. However, the depth information collected by the above devices often only reflects the geometric characteristics of parallel plates installed in the lifting shelf, resulting in certain errors in the positioning results for the lifting shelf, and poor accuracy in the positioning results.

### SUMMARY

The present application provides a shelf positioning method, a shelf connecting method and device, equipment and a medium to improve the positioning accuracy of movable equipment and connecting efficiency.

In a first aspect, the present application provides a shelf positioning method, which comprises:
acquiring image data, in an environment where a movable equipment is located, through an image acquisition module in the movable equipment;
inputting the image data into a key point detection network to extract first position information of shelf key points in an image coordinate system from the image data through the key point detection network; and
determining a relative pose of the shelf key points relative to the movable equipment according to the first position information and a conversion relationship between the image coordinate system and a vehicle body coordinate system of the movable equipment.

In a second aspect, the present application provides a shelf positioning device, which comprises:
an acquisition module configured to acquire image data, in an environment where a movable equipment is located, through an image acquisition module in the movable equipment;
a key point detection module configured to input the image data into a key point detection network to extract first position information of shelf key points in an image coordinate system from the image data through the key point detection network; and
a relative pose determination module configured to determine a relative pose of the shelf key points relative to the movable equipment according to the first position information and a conversion relationship between the image coordinate system and a vehicle body coordinate system of the movable equipment.

In a third aspect, the present application provides a shelf connecting method, which comprises:
acquiring image data, in an environment where a movable equipment is located, through an image acquisition module in the movable equipment;
inputting the image data into a key point detection network to extract first position information of shelf key points in an image coordinate system from the image data through the key point detection network;
determining a relative pose of the shelf key points relative to the movable equipment according to the first position information and a conversion relationship between the image coordinate system and a vehicle body coordinate system of the movable equipment; and
determining a connecting route between the movable equipment and a shelf according to the relative pose, so that the movable equipment starts a connecting process based on the connecting route.

In a fourth aspect, the present application provides a shelf connecting device, which comprises:
an acquisition module configured to acquire image data, in a environment where a movable equipment is located, through an image acquisition module in the movable equipment;
a key point detection module configured to input the image data into a key point detection network to extract first position information of shelf key points in an image coordinate system from the image data through the key point detection network;
a relative pose determination module configured to determine relative pose of the shelf key points relative to the movable equipment according to the first position information and a conversion relationship between the image coordinate system and a vehicle body coordinate system of the movable equipment; and

a connection module configured to determine a connecting route between the movable equipment and a shelf according to the relative pose, so that the movable equipment starts a connecting process based on the connecting route.

In a fifth aspect, the present application provides electronic equipment, which comprises a processor and a memory, wherein an executable code is stored on the memory, and when executed by the processor, the executable code causes the processor to at least implement the method in the first or third aspect.

In a sixth aspect, the present application provides a non-transitory machine-readable storage medium having an executable code stored thereon, wherein when executed by a processor of electronic equipment, the executable code causes the processor to at least implement the method in the first or third aspect.

In the embodiments of the present application, the image data in the environment where the movable equipment is located are acquired first through the image acquisition module in the movable equipment, then the image data are input into the key point detection network to extract the first position information of the shelf key points in the image coordinate system from the image data through the key point detection network, and finally, according to the first position information and the conversion relationship between the image coordinate system and the vehicle body coordinate system of the movable equipment, the relative pose of the shelf key points relative to the movable equipment is determined.

In the embodiments of the present application, visual semantic features of a shelf (that is, position information of the shelf key points) are extracted from the image data of the environment where the movable equipment is located through the key point detection network, and the relative pose of the shelf relative to the movable equipment is determined based on the visual semantic features, which makes the detection of the position of the shelf more accurate, and improves the accuracy of shelf positioning. Furthermore, the embodiments of the present application can identify the visual semantic features of the shelf through the key point detection network without the need to collect depth information, thereby expanding the application scope of shelf positioning and reducing the hardware cost of shelf positioning.

### BRIEF DESCRIPTION OF THE DRAWINGS

In order to explain the technical scheme of the present application more clearly, the drawings needed in the description of the present application will be briefly introduced below. Obviously, the drawings in the following description illustrate some embodiments of the present application. For those of ordinary skill in the art, other drawings can be obtained according to these drawings without creative work.

FIG. 1 is a flowchart of a shelf positioning method provided by the present application;

FIGS. 2-5 are schematic diagrams of a shelf positioning method provided by the present application;

FIG. 6 is a flowchart of another shelf positioning method provided by another embodiment of the present application;

FIG. 7 is a flowchart of a shelf connecting method provided by the present application;

FIG. 8 is a schematic diagram of a shelf connecting method provided by the present application;

FIG. 9 is a flowchart of another shelf connecting method provided by another embodiment of the present application;

FIG. 10 is a structural diagram of a shelf positioning device provided by the present application;

FIG. 11 is a structural diagram of a shelf connecting device provided by the present application; and

FIG. 12 is a structural diagram of electronic equipment provided by the present application.

### DETAILED DESCRIPTION OF EMBODIMENTS

In order to make the purpose, technical scheme and advantages of the embodiments of the present application clearer, the technical scheme in the embodiments of the present application will be clearly and completely described below in combination with attached drawings. Obviously, the described embodiments are only part of the embodiments of the present application, not all of them. Based on the embodiments of the present application, all other embodiments obtained by those of ordinary skill in the art without creative labor shall belong to the scope of protection of the present application.

Terms used in the embodiments of the present application are for the purpose of describing specific embodiments only, and are not intended to limit the present application. As used in the embodiments of the present application and the appended claims, the singular forms “a”, “said” and “the” are also intended to include the plural forms, and unless the context clearly indicates other meanings, “a plurality of” generally means at least two.

Depending on the context, the word “if” as used herein can be interpreted as “when” or “in response to determination” or “in response to detection”. Similarly, depending on the context, the phrase “if determined” or “if detected (stated condition or event)” can be interpreted as “when determined” or “in response to determination” or “when detected (stated condition or event)” or “in response to detection (stated condition or event)”.

In addition, the sequence of steps in each of the following method embodiments is only an example, and is not intended to be limiting.

In the related art, movable equipment is an important part of an automated warehousing and logistics system. In the warehousing and logistics scenario, movable equipment is connected with shelves to move and unload goods to achieve the automated scheduling and handling of warehouse goods by connecting.

Taking the example of a lifting shelf, before the movable equipment is connected with the lifting shelf, it is necessary to position the lifting shelf. In the related art, LiDAR, solid-state radar, RGBD cameras and other devices are usually used to collect depth information of the lifting shelf, and then position the insertable side of the lifting shelf based on the depth information. However, the depth information collected by the above devices often only reflects the geometric characteristics of parallel plates installed in the lifting shelf, resulting in certain errors in the positioning results for the lifting shelf, and poor accuracy in the positioning results.

In order to solve the above problems, the core idea of the technical scheme provided by the embodiments of the present application is as follows.

Image data in an environment where a movable equipment is located are acquired first through an image acquisition module in the movable equipment, then the image data are input into a key point detection network to extract first position information of shelf key points in an image coordinate system from the image data through the key point detection network, and finally, according to the first position information and a conversion relationship between the image coordinate system and a vehicle body coordinate system of the movable equipment, a relative pose of the shelf key points relative to the movable equipment is determined.

In this scheme, visual semantic features of a shelf (such as first position information of the shelf key points) are extracted from the image data of the environment where the movable equipment is located through the key point detection network, and the relative pose of the shelf relative to the movable equipment is determined based on the visual semantic features, which makes the detection of the position of the shelf more accurate, and improves the accuracy of shelf positioning. Furthermore, this scheme can identify the visual semantic features of the shelf through the key point detection network without the need to collect depth information, thereby expanding the application scope of shelf positioning and reducing the hardware cost of shelf positioning.

After the core idea of the technical scheme is introduced, various non-limiting embodiments of the present application will be described in detail below.

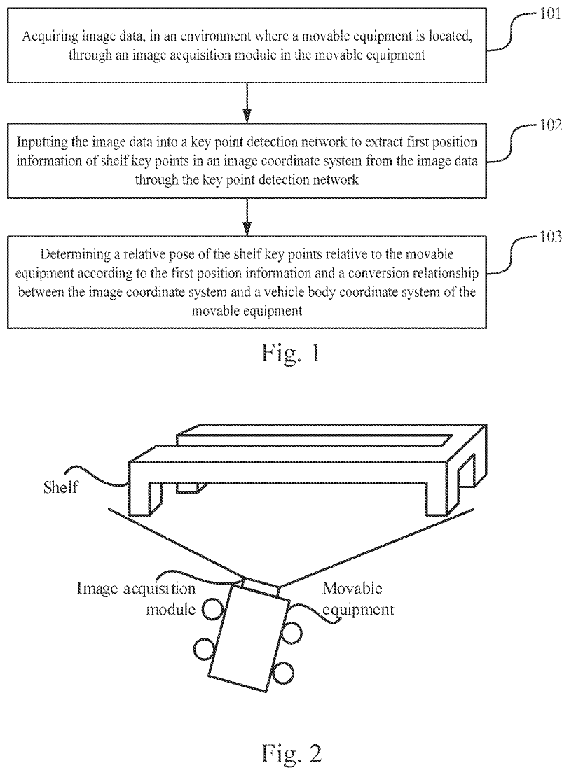

FIG. 1 is a flowchart of a shelf positioning method provided by an embodiment of the present application. As shown in FIG. 1, the method comprises the following steps:

101, acquiring image data, in an environment where a movable equipment is located, through an image acquisition module in the movable equipment;

102, inputting the image data into a key point detection network to extract first position information of shelf key points in an image coordinate system from the image data through the key point detection network; and

103, determining a relative pose of the shelf key points relative to the movable equipment according to the first position information and a conversion relationship between the image coordinate system and a vehicle body coordinate system of the movable equipment.

In the embodiment of the present application, the movable equipment may be an autonomous mobile robot (AMR), a cargo vehicle, and the like. Specifically, AMR refers to the equipment that can move in a space with a high degree of autonomy in the working environment, such as warehouse cooperative robots, picking robots or transfer robots.

Taking AMR as an example, a semantic map corresponding to the environment where the AMR is located exists in the AMR, which refers to an environment map containing semantic information of multiple objects in the environment. The semantic information of an object refers to information that can be understood and interpreted in a natural language, such as what the object is or its category, including but not limited to the name, shape, and position of the object. For example, in the warehousing environment, the semantic map includes the positions, types, and sizes of various shelves in the warehouse, as well as the positions, types, and sizes of various obstacles (such as railings, steps and thresholds) in the warehouse.

In the embodiment of the present application, the image acquisition module of the movable equipment may be a sensor module with the image acquisition capability. For example, the image acquisition module is a wide-angle monocular camera for capturing red green blue (RGB) images. It can be understood that in practical applications, RGB images include pictures or videos.

The method provided by the embodiment of the present application can be realized by a control and scheduling terminal of multiple pieces of movable equipment, and can also be realized by the multiple pieces of movable equipment. In practical applications, the control and scheduling terminal of the multiple pieces of movable equipment can be set in a cloud service center, or in one of the multiple pieces of movable equipment, or in other forms of computing devices, which is not limited here.

In practical applications, the method provided by the embodiment of the present application can be applied to various scenarios, such as warehousing scenario, sorting scenario, material distribution scenario, and port freight scenario. The specific implementation of the embodiment of the present application will be introduced below by taking the warehousing scenario as an example, and other scenarios can be implemented with reference to the implementation of the warehousing scenario, which will not be repeated here.

Taking the warehousing scenario as an example, the warehousing scenario refers to a scenario of storing goods in a space such as a warehouse, a freight house and a storehouse. In the storage scenario, there are stored goods and multiple shelves for storing goods. Further, the shelf comprises shelf boards and shelf frames.

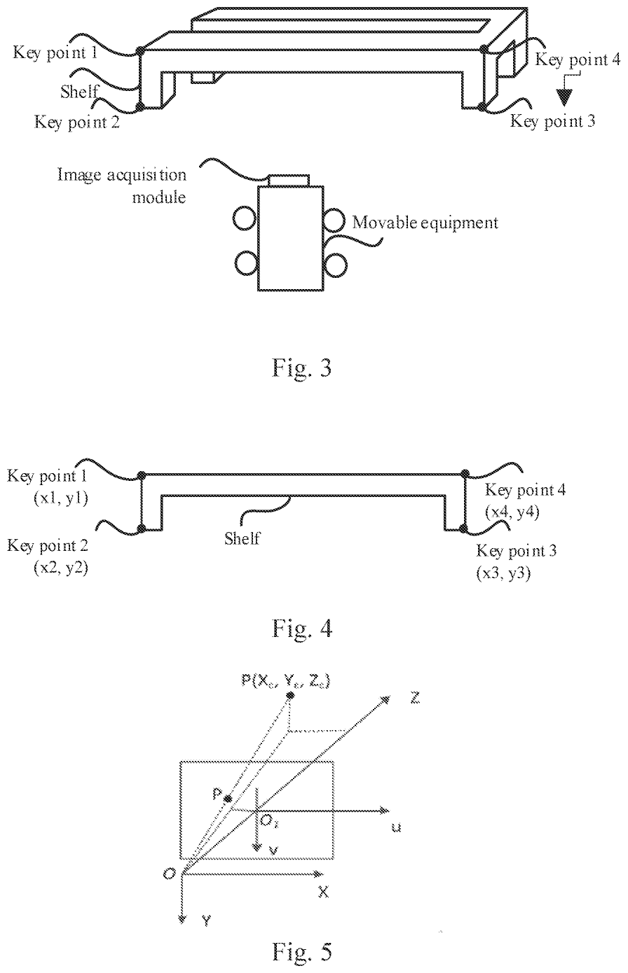

In the warehousing scenario, during the movement of the movable equipment, the image data in the environment where the movable equipment is located can be collected through the image acquisition module. The environment in which the movable equipment is located refers to part of the warehousing scenario near the movable equipment. The range of image data that the movable equipment can collect in the warehousing scenario is related to the field of view of the image acquisition module. The larger the field of view of the image acquisition module, the larger the range of image data it collects. After the image data in the warehousing scenario is collected, key point detection can be performed on the image data in the warehousing scenario through the key point detection network to detect the shelf key points in the image data. Taking the warehousing scenario shown in FIG. 2 as an example, the movable equipment captures images of the shelf through the image acquisition module, and the collected image data are input into the key point detection network, so that the shelf key points contained in the image data are detected through the key point detection network, as shown in FIG. 3.

Specifically, first position information of the shelf key points in the image coordinate system is extracted from the image data through the key point detection network. As shown in FIG. 3, positions of a top left vertex, a bottom left vertex, a bottom right vertex and a top right vertex of the shelf are marked through the key point detection network, and corresponding key points 1, 2, 3 and 4 are marked in the image data to obtain the first position information of the four shelf key points shown in FIG. 4. Further, after the first position information of the shelf key points is acquired, determining the relative pose of the shelf key points relative to the movable equipment according to the first position information of the shelf key points and the conversion relationship between the image coordinate system and the vehicle body coordinate system of the movable equipment, that is, relative pose the relative pose of the shelf relative to the movable equipment.

In the embodiment of the present application, positions of the shelf key points are detected by visual feature extraction technology, realizing a high detection speed; moreover, the visual features extracted by the key point detection network are not easily influenced by other interference factors, false detection caused by depth information can be avoided, a foundation is provided for the positioning scheme of the movable equipment to get rid of the dependence on the depth information, positioning accuracy and flexibility are improved, and the application range of the shelf positioning method is greatly expanded.

In practical applications, any model with an image detection (or identification) function can be used as the key point detection network mentioned in the above steps, which is not limited here. Preferably, various neural network models can be used as the key point detection network, such as convolutional neural network (CNN). Specifically, shelf key points are marked in image data containing a shelf, and then a CNN is trained using the marked image data, so that a CNN for detecting the shelf key points can be obtained.

The specific implementation of each step shown in FIG. 1 will be described with reference to the attached drawings.

It is assumed that there is movable equipment in a specific application scenario and the specific application scenario contains a shelf for storing goods. In practical applications, the shelf can be a lifting shelf as shown in FIG. 2. It is assumed that a wide-angle monocular camera is installed in the movable equipment.

Based on the above assumptions, optionally, the step 101 of, acquiring image data in the environment where a movable equipment is located through an image acquisition module in the movable equipment, can be implemented as: acquiring RGB images containing shelf images through the wide-angle monocular camera of the movable equipment.

Specifically, as shown in FIG. 2, in a optional embodiment, the movable equipment moves to the front of the shelf, takes the shelf as a photographing target, and obtains the RGB images containing the shelf images through the wide-angle monocular camera.

In addition, in the embodiment of the present application, the image data in the environment where the movable equipment is located can also be obtained in other ways. For example, in another embodiment, during the movement of the movable equipment, the surrounding area is scanned by the wide-angle monocular camera to obtain RGB videos corresponding to the surrounding area. The RGB videos are input into an image identification network to extract image frames containing the target shelf from the RGB videos through the image identification network as the RGB images containing the shelf images.

It can be understood that no matter what image acquisition method is adopted, the goal is to obtain two-dimensional image data containing the shelf images to provide a basis for the subsequent detection of shelf key points.

In the embodiment of the present application, it is assumed that the image acquisition module is a wide-angle monocular camera, the wide-angle shooting function of which may cause distortion in the image data.

To prevent subsequent positioning calculation from being affected by the distortion, in the embodiment of the present application, optionally, after the image data in the environment where the movable equipment is located is acquired, distortion correction is performed on coordinates of each pixel point in the image data according to focal length parameters and distortion parameters of the image acquisition module.

For example, suppose each pixel in the image data is denoted as (u₀, v₀). Let the focal length parameters of the image acquisition module be (fₓ, fᵥ) and the distortion parameters be (k₁, k₂, k₃, p₁, p₂). Suppose the image has a width W and height H. Based on these assumptions, corrected pixel coordinates (u₁, v₁) are calculated using the following formula:

$$\{ \begin{matrix}x = ( {u}_{0} - 0.5 \times W ) / {f}_{x} \\ y = ( {v}_{0} - 0.5 \times H ) / {f}_{y}\end{matrix} \\ \{ \begin{matrix}r = {x}^{2} + {y}^{2} \\ {x}_{1} = x \times ( 1 + {k}_{1} \times r + {k}_{2} \times {r}^{2} + {k}_{3} \times {r}^{3} ) + 2 \times {p}_{1} \times x \times y + {p}_{2} \times ( r + 2 \times {x}^{2} ) \\ {y}_{1} = y \times ( 1 + {k}_{1} \times r + {k}_{2} \times {r}^{2} + {k}_{3} \times {r}^{3} ) + 2 \times {p}_{2} \times x \times y + {p}_{1} \times ( r + 2 \times {y}^{2} )\end{matrix} \\ \{ \begin{matrix}{u}_{1} = {x}_{1} \times {f}_{x} + 0.5 \times W \\ {v}_{1} = {y}_{1} \times {f}_{y} + 0.5 \times H\end{matrix}$$

Further, in 102, the image data after distortion correction are input into the key point detection network to extract the first position information of the shelf key points in the image coordinate system from the image data through the key point detection network. Through the detected shelf key points, the overall outline of the shelf can be constructed, thus providing a basis for the subsequent acquisition of the relative pose of the shelf key points relative to the movable equipment where the image acquisition module is located.

In practical applications, the first position information is pixel coordinates corresponding to the shelf key points in the two-dimensional image coordinate system. For example, suppose the shelf key points of a shelf are labelled as key point 1, key point 2, key point 3, and key point 4. Based on this, in the shelf picture shown in FIG. 4, the pixel coordinates of the above four shelf key points in the shelf picture are detected. Specifically, the pixel coordinates of the shelf key points are sequentially read from the key point detection network, and denoted as the top left vertex (x1, y1), the bottom left vertex (x2, y2), the bottom right vertex (x3, y3) and the top right vertex (x4, y4). In addition to the illustrative order and quantity, the output of the key point detection network can also be configured according to the actual application scenario.

In practical applications, optionally, the shelf key points in the embodiment of the present application can be marked in advance according to the actual shelf shape. Specifically, in the process of training the key point detection network, the positions of the shelf key points are marked in advance in the image data containing the shelf, and the marked image data are used as a training sample for the key point detection network. For example, the shelf picture and the two-dimensional coordinates of the shelf key points in the shelf picture are taken as a set of training samples. The shelf contained in the shelf picture may be complete or only a part of it.

To improve the accuracy of shelf positioning, optionally, a number threshold corresponding to the shelf key points is set in advance, and the number of shelf key points extracted by the key point detection network is compared with the number threshold. If they are not consistent, it indicates that not all the shelf key points have been extracted. In this case, the movable equipment can be moved to a position where all the shelf key points can be captured. If they are consistent, it indicates that all the shelf key points have been extracted, and in this case, step 103 can be executed.

Further, optionally, the step 103 of, determining a relative pose of the shelf key points relative to the movable equipment according to the first position information of the shelf key points in the image data and a conversion relationship between the image coordinate system and a vehicle body coordinate system of the movable equipment, can be implemented as:
calculating second position information of the shelf key points in the vehicle body coordinate system according to preset shelf parameters, camera parameters of the image acquisition module and the first position information; and calculating the relative pose of the shelf key points relative to the movable equipment based on the conversion relationship between the image coordinate system and the vehicle body coordinate system of the movable equipment and the second position information.

Here, the conversion relationship between the image coordinate system and the vehicle body coordinate system of the movable equipment is obtained based on a relative position relationship between the image acquisition module and the movable equipment. The vehicle body coordinate system of the movable equipment refers to a three-dimensional coordinate system with a vehicle body as the origin in the physical world.

It is assumed that the shelf parameters comprise shelf dimensions. The shelf dimensions comprise the length, width and height of the shelf. It is assumed that the camera parameters comprise focal length parameters. Based on this, the above step of, calculating second position information of the shelf key points in the vehicle body coordinate system according to preset shelf parameters, camera parameters of the image acquisition module and the first position information, comprises: converting two-dimensional coordinates of the shelf key points in the image coordinate system into the vehicle body coordinate system according to the shelf dimensions and the focal length parameters, to obtain three-dimensional coordinates of the shelf key points in the vehicle body coordinate system.

Specifically, as shown in FIG. 5, in an alternative embodiment, it is assumed that O is the origin of the image coordinate system and O₁ is the origin of the vehicle body coordinate system. Based on this, referring to the mapping process shown in FIG. 5, the two-dimensional coordinates P (u₁, v₁) of the shelf key points can be mapped from the image coordinate system to the vehicle body coordinate system and converted into the corresponding three-dimensional coordinates P(x_{c}, y_{c}, z_{c}).

It is further assumed that the width and height in the shelf dimensions are denoted as z_{c}, and the focal length parameters are (fₓ, fᵥ). Based on the above assumptions, the coordinate system conversion process can be realized by the following formula, and the three-dimensional coordinates P(x_{c}, y_{c}, z_{c}) of the shelf key points in the vehicle body coordinate system can be obtained, that is:

$${z}_{c} \times [ \begin{matrix}{u}_{1} \\ {v}_{1} \\ 1\end{matrix} ] = [ \begin{matrix}{f}_{x} & 0 & 0 \\ 0 & {f}_{y} & 0 \\ 0 & 0 & 1\end{matrix} ] \times [ \begin{matrix}{x}_{c} \\ {y}_{c} \\ {z}_{c}\end{matrix} ]$$

The above formula can be simplified as:

$$\{ \begin{matrix}{x}_{c} = {z}_{c} \times {u}_{1} / {f}_{x} \\ {y}_{c} = {z}_{c} \times {v}_{1} / {f}_{y}\end{matrix}$$

To further improve the accuracy of shelf positioning, optionally, before calculating the relative pose of the shelf key points relative to the movable equipment based on the conversion relationship and the second position information, the method further comprises: correcting the second position information according to inherent structural features of the shelf.

It is worth noting that the inherent structural features of the shelf refer to specific geometric characteristics based on the shelf structure. For example, the inherent structural features of a shelf comprise, but are not limited to, vertical edges of the shelf being parallel to each other, and/or horizontal edges of the shelf being parallel to each other.

Based on the above inherent structural features, for example, suppose that the three-dimensional coordinates of four shelf key points in the vehicle body coordinate system obtained based on the two-dimensional coordinate conversion shown in FIG. 4 are denoted as the top left vertex (x1, y1, z1), the bottom left vertex (x2, y2, z2), the bottom right vertex (x3, y3, z3) and the top right vertex (x4, y4, z4).

Based on the above assumptions, by determining whether a difference in horizontal coordinates of two vertices on one plane is equal to a difference in horizontal coordinates of two vertices on another plane, whether the vertical edges of the shelf are parallel to each other is determined. That is, if x4-x1=x3-x2, then the vertical edges of the shelf are parallel to each other. If x4-x1≠x3-x2, then the vertical edges of the shelf are not parallel to each other.

In another example, still based on the above assumptions, by determining whether a difference in longitudinal coordinates of two vertices on one side is equal to a difference in longitudinal coordinates of two vertices on another side, whether the horizontal edges of the shelf are parallel to each other is determined. That is, if z4-z3=z2-z1, then the horizontal edges of the shelf are parallel to each other. If z4-z3≠z2-z1, then the horizontal edges of the shelf are not parallel to each other.

Finally, based on the corrected second position information and the conversion relationship between the image coordinate system and the vehicle body coordinate system of the movable equipment, the relative pose of the shelf key points relative to the movable equipment is obtained. This relative pose is used for subsequent positioning and insertion of the shelf.

In the shelf positioning method shown in FIG. 1, visual semantic features of a shelf are extracted from the image data of the environment where the movable equipment is located through the key point detection network, and the relative pose of the shelf relative to the movable equipment is determined based on the visual semantic features, which makes the detection of the position of the shelf more accurate, and improves the accuracy of shelf positioning. Furthermore, the embodiments of the present application can identify the visual semantic features of the shelf through the key point detection network without the need to collect depth information, thereby greatly expanding the application scope of shelf positioning and reducing the hardware cost of shelf positioning.

Further, according to another embodiment of the present application, the above-mentioned image acquisition module can also be used together with a LiDAR, allowing the relative coordinates obtained from the image data obtained by the image acquisition module to be fused with point cloud data obtained by the LiDAR. In this way, the point cloud data obtained by the LiDAR can be used as a supplement to the visual image data, allowing for additional correction to prevent significant deviation in positioning results based on visual data and improve the accuracy of shelf positioning.

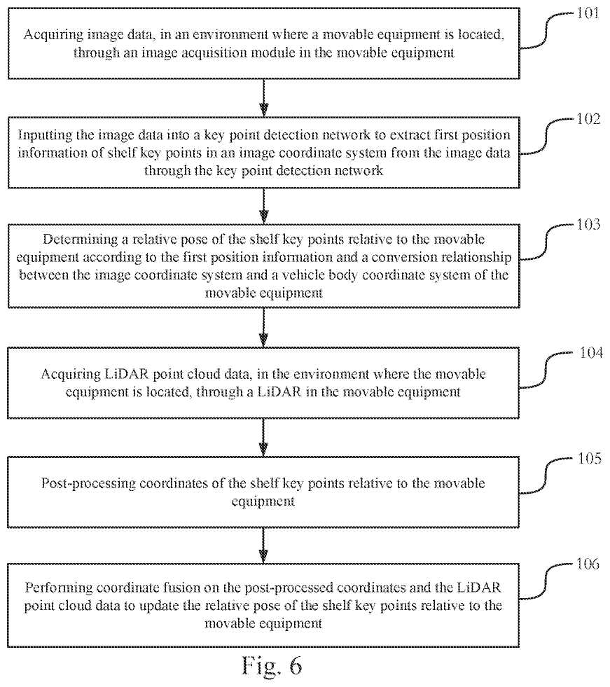

FIG. 6 is a flowchart of another shelf positioning method provided by an embodiment of the present application. As shown in FIG. 6, in addition to steps 101, 102, and 103, the method may further comprise steps 104, 105, and 106. The detailed implementation process and technical effects of steps 101, 102, and 103 have been described in detail above and will not be repeated here.

In step 104, acquiring LiDAR point cloud data, in the environment where the movable equipment is located, through a LiDAR in the movable equipment. In addition to the image acquisition module such as wide-angle monocular camera, the movable equipment can also be equipped with the LiDAR for acquiring the point cloud data in the environment where the movable equipment is located.

In step 105, post-processing coordinates of the shelf key points relative to the movable equipment. In the above step 103, the coordinates of the shelf key points relative to the movable equipment have been obtained through coordinate conversion. In this step, the prior knowledge of the shelf can be used to further correct the three-dimensional coordinates of the shelf key points relative to the movable equipment. For example, the vertical edge of the shelf is vertical to the ground, and the horizontal edge is horizontal to the ground.

As described above, suppose that the three-dimensional coordinates of the shelf key points in the vehicle body coordinate system are denoted as the top left vertex (x1, y1, z1), the bottom left vertex (x2, y2, z2), the bottom right vertex (x3, y3, z3) and the top right vertex (x4, y4, z4). In the case of the top left vertex, the coordinates after further correction in step 105 are:

$$x {1}_{new} = x {2}_{new} = ( x 1 + x 2 ) / 2 ; \\ z {1}_{new} = z {2}_{new} = ( z 1 + z 2 ) / 2 ; \\ y {1}_{new} = y {4}_{new} = ( y 1 + y 4 ) / 2.$$

In step 106, performing coordinate fusion on the post-processed coordinates and the LiDAR point cloud data to update the relative pose of the shelf key points relative to the movable equipment. The width wid of the shelf can be calculated based on the coordinates of the bottom left vertex and the bottom right vertex (or the top left vertex and the top right vertex) corrected in step 105. Taking the laser point cloud data obtained by single-line LiDAR as an example, because the point cloud of the single-line LiDAR is distributed on a plane parallel to the ground, it is possible to search for the point cloud within a circular area with (x2, z2) as the center and wid*0.1 as the radius. If there are multiple laser points, the average of three points closest to the vehicle body of the movable equipment and (x2, z2) will be taken as the new coordinates of the bottom left vertex. If the number of laser points in the circular area is less than 3, the average of the actual number of laser points and (x2, z2) will be taken as the new coordinates of the bottom left vertex. If there is no laser point in the circular area, it will be treated as false detection and discarded. The coordinates of the bottom right vertex can be updated similarly.

Therefore, by using the laser point cloud data detected by the LiDAR as a supplement to the image data obtained by the image acquisition module, significant deviation in positioning results based on image data can be avoided, thereby improving the accuracy of shelf positioning.

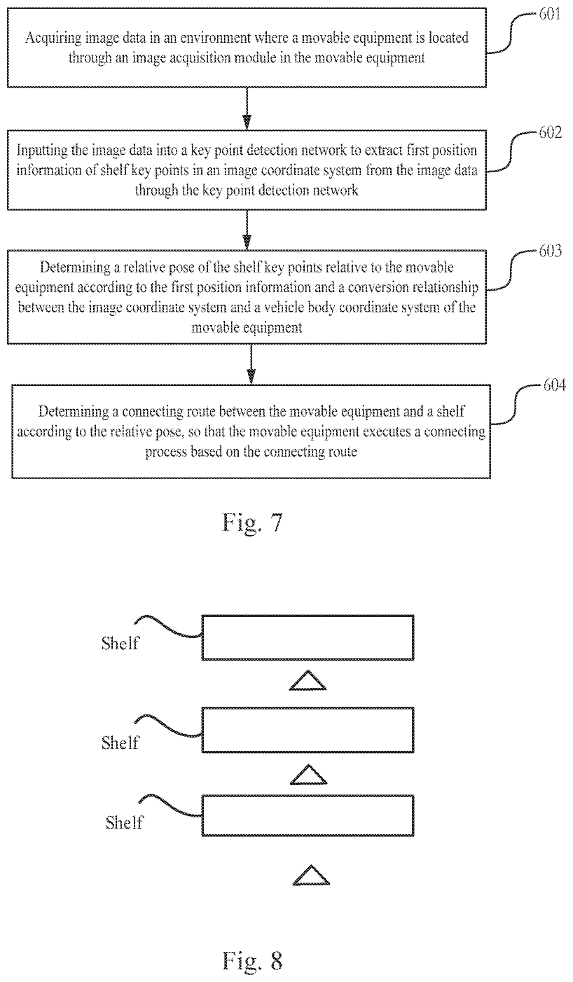

FIG. 7 is a flowchart of a shelf connecting method provided by an embodiment of the present application. As shown in FIG. 7, the method comprises the following steps:

601, acquiring image data in an environment where a movable equipment is located through an image acquisition module in the movable equipment;

602, inputting the image data into a key point detection network to extract first position information of shelf key points in an image coordinate system from the image data through the key point detection network;

603, determining a relative pose of the shelf key points relative to the movable equipment according to the first position information and a conversion relationship between the image coordinate system and a vehicle body coordinate system of the movable equipment; and

604, determining a connecting route between the movable equipment and a shelf according to the relative pose, so that the movable equipment executes a connecting process based on the connecting route.

The specific implementation of the above steps 601 to 603 is similar to the steps 101 to 103 in the method shown in FIG. 1, and the detailed implementation process and technical effects have been described in the previous embodiment and will not be repeated here.

In the warehousing scenario, during the movement of the movable equipment, the image data in the environment where the movable equipment is located can be collected through the image acquisition module. Because the larger the field of view of the image acquisition module, the larger the range of image data it collects, a wide-angle monocular camera is optionally adopted in the present application.

After the image data in the warehousing scenario is collected, key point detection can be performed on the image data in the warehousing scenario through the key point detection network to detect the shelf key points in the image data. Taking the warehousing scenario shown in FIG. 2 as an example, the movable equipment captures images of the shelf through the image acquisition module, and the collected image data are input into the key point detection network, so that the shelf key points contained in the image data are detected through the key point detection network, as shown in FIG. 3. Specifically, first position information of the shelf key points in the image coordinate system is extracted from the image data through the key point detection network. As shown in FIG. 3, positions of a top left vertex, a bottom left vertex, a bottom right vertex and a top right vertex of the shelf are marked through the key point detection network, and corresponding key points 1, 2, 3 and 4 are marked in the image data to obtain the first position information of the four shelf key points shown in FIG. 4. Further, after the first position information of the shelf key points is acquired, determining the relative pose of the shelf key points relative to the movable equipment according to the first position information of the shelf key points and the conversion relationship between the image coordinate system and the vehicle body coordinate system of the movable equipment. After the relative pose of the shelf key points relative to the movable equipment is determined, determining a connecting route between the movable equipment and a shelf according to the relative pose, so that the movable equipment executes a connecting process based on the connecting route.

In the embodiments of the present application, visual semantic features of a shelf (that is, position information of the shelf key points) are extracted from the image data of the environment where the movable equipment is located through the key point detection network, and the relative pose of the shelf relative to the movable equipment is determined based on the visual semantic features. Further, based on the relative pose of the shelf relative to the movable equipment, the connecting route between the movable equipment and the shelf is planned, so that the movable equipment starts a connecting process based on the connecting route. In this way, the connection between the movable equipment and the shelf is realized, the detection of the position of the shelf is more accurate, and the accuracy of shelf positioning and shelf connection is improved.

Some optional steps of the shelf connecting method will be introduced below with reference to the attached drawings. The following optional steps can also be used in corresponding embodiments of the shelf positioning method shown in FIG. 1.

In an alternative embodiment, the movable equipment is navigated to a connecting position matched with the shelf to be connected. Here, the connecting position is a position for collecting at least one shelf key point in the environment where the movable equipment is located. Further, according to historical key point detection results, the connecting positions of each shelf can be marked in a warehouse environment map, facilitating subsequent positioning and navigation of the movable equipment to the connecting positions, thereby improving the efficiency of shelf positioning and connection. For example, in the warehouse environment map shown in FIG. 8, optional connecting positions of each shelf are marked with triangle markers based on historical key point detection results.

Based on the connecting position, the step 601 of, acquiring image data in the environment where a movable equipment is located through an image acquisition module in the movable equipment, comprises: in the connecting position, photographing the image data in the environment where the movable equipment is located through the image acquisition module.

Through the above steps, the movable equipment can reach a position where the shelf key points can be photographed more quickly. This not only enhances the accuracy of shelf positioning but also reduces the time required for shelf connection, thereby improving efficiency.

In another alternative embodiment, optionally, whether the shelf key points extracted by the key point detection network meet preset conditions is determined. If the shelf key points do not meet the preset conditions, the movable equipment is controlled to move around the shelf. During the movement of the movable equipment, steps 601 to 602 are re-executed until the shelf key points extracted by the key point detection network meet the preset conditions.

For example, suppose that the preset condition is that the number of extracted shelf key points reaches a preset number threshold. Based on this, whether the number of shelf key points extracted by the key point detection network reaches the preset number threshold is determined. If the number of shelf key points does not reach the preset number threshold, it means that the movable equipment has not collected all shelf key points. To put it simply, an angle at which the movable equipment collects the shelf image does not reach a preset angle, and the movable equipment is not at a preset position. In this case, the movable equipment is controlled to move around the shelf to reach the preset position. During the movement of the movable equipment, steps 601 to 602 are re-executed until the number of shelf key points extracted by the key point detection network reaches the preset number threshold, at which point it can be confirmed that the movable equipment has reached the preset position.

In addition to the number of shelf key points, the quality and acquisition angle of the image data can be filtered through preset conditions to improve the accuracy of shelf positioning results and connecting results.

Through the above steps, the movable equipment can be controlled to reach the preset position (that is, the position where all the shelf key points can be collected). This not only enhances the accuracy of shelf positioning and connection but also reduces the time required for shelf connection, thereby improving efficiency.

In another alternative embodiment, in the connecting process, issues such as a long distance from the shelf, skewed angles in photographing the shelf, and deviation in the traveling path of the movable equipment may arise. Therefore, during the connecting process, the image data in the environment where the movable equipment is located can be re-acquired through the image acquisition module, and steps 602 to 603 can be re-executed to recalculate the relative pose, correct the connecting process and improve the connecting efficiency.

Specifically, in an alternative embodiment, the process of re-executing the step of determining the relative pose to correct the connecting route comprises: re-executing steps 602 to 603 to obtain the relative pose of the shelf key points relative to the movable equipment; and re-determining the connecting route between the movable equipment and the shelf according to the recalculated relative pose, so that the movable equipment corrects the connecting process based on the re-determined connecting route.

Through the above steps, the relative pose can be recalculated, allowing the connecting route to be re-determined in the event of the mentioned issues, so as to correct the connecting process. This further improves the accuracy of shelf connection, shortens the time spent in the process of shelf connection, and improves efficiency.

Further, according to another embodiment of the application, the above-mentioned image acquisition module can also be used together with LiDAR, allowing the relative coordinates obtained from the image data obtained by the image acquisition module to be fused with point cloud data obtained by the LiDAR.

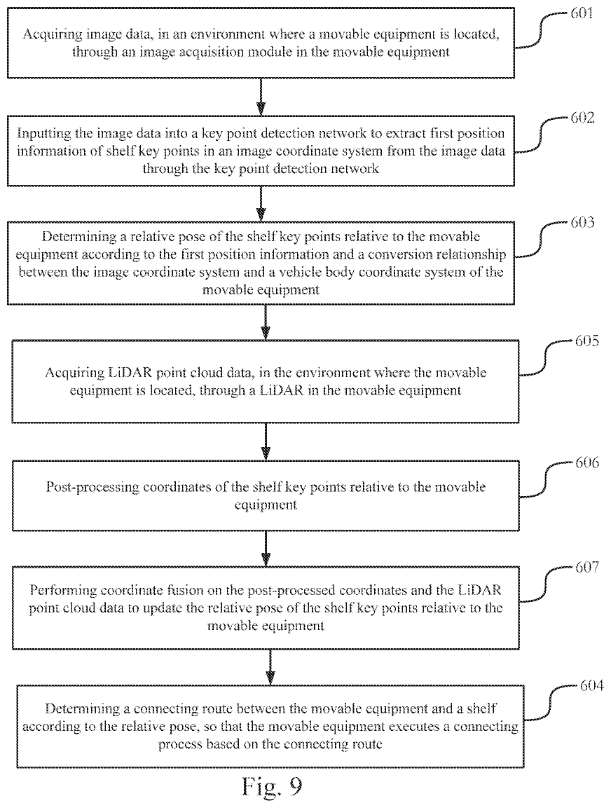

FIG. 9 is a flowchart of another shelf connecting method provided by an embodiment of the present application. As shown in FIG. 9, in addition to steps 601, 602, 603, and 604, the method may further comprise steps 605, 606, and 607 between the steps 603 and 604. The detailed implementation process and technical effects of steps 601, 602, 603, and 604 have been described in detail above and will not be repeated here.

In 605, acquiring LiDAR point cloud data, in the environment where the movable equipment is located, through a LiDAR in the movable equipment.

In 606, post-processing coordinates of the shelf key points relative to the movable equipment.

In 607, performing coordinate fusion on the post-processed coordinates and the LiDAR point cloud data to update the relative pose of the shelf key points relative to the movable equipment.

The detailed execution process and technical effects of steps 605, 606 and 607 are similar to those of steps 104, 105 and 106 respectively, and will not be repeated here.

Devices in one or more embodiments of the present application will be described in detail below. Those skilled in the art can understand that these devices can be configured by the steps taught in this scheme using commercially available hardware components.

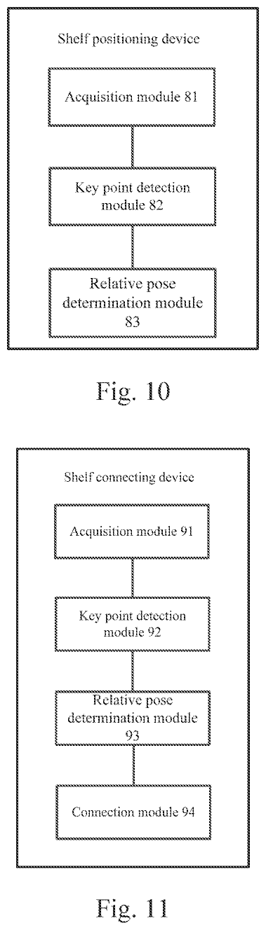

FIG. 10 is a structural diagram of a shelf positioning device provided by an embodiment of the present application. As shown in FIG. 10, the device comprises:
an acquisition module 81 configured to acquire image data, in an environment where the movable equipment is located, through an image acquisition module in movable equipment;
a key point detection module 82 configured to input the image data into a key point detection network to extract first position information of shelf key points in an image coordinate system from the image data through the key point detection network; and
a relative pose determination module 83 configured to determine a relative pose of the shelf key points relative to the movable equipment according to the first position information and a conversion relationship between the image coordinate system and a vehicle body coordinate system of the movable equipment.

Optionally, when determining the relative pose of the shelf key points relative to the movable equipment according to the first position information and a conversion relationship between the image coordinate system and a vehicle body coordinate system, the relative pose determination module 83 is specifically configured to:
calculate second position information of the shelf key points in the vehicle body coordinate system according to preset shelf parameters, camera parameters of the image acquisition module and the first position information; and
calculate the relative pose of the shelf key points relative to the movable equipment based on the conversion relationship and the second position information;
wherein, the conversion relationship is obtained based on a relative position relationship between the image acquisition module and the movable equipment.

Optionally, the shelf parameters comprise shelf dimensions and the camera parameters comprise focal length parameters.

When calculating second position information of the shelf key points in the vehicle body coordinate system according to preset shelf parameters, camera parameters of the image acquisition module and the first position information, the relative pose determination module 83 is specifically configured to:
convert two-dimensional coordinates of the shelf key points in the image coordinate system into the vehicle body coordinate system according to the shelf dimensions and the focal length parameters, to obtain three-dimensional coordinates of the shelf key points in the vehicle body coordinate system.

Optionally, the device further comprises a modification module configured to:
correct the second position information according to inherent structural features of a shelf before calculating the relative pose of the shelf key points relative to the movable equipment based on the conversion relationship and the second position information;
here, the inherent structural features comprise: vertical edges of the shelf being parallel to each other, and/or horizontal edges of the shelf being parallel to each other.

Optionally, the device further comprises a distortion correction module configured to:
perform distortion correction on coordinates of each pixel point in the image data according to focal length parameters and distortion parameters of the image acquisition module before inputting the image data into a key point detection network.

Optionally, the shelf key points comprise any one or more of a top left vertex, a top right vertex, a bottom left vertex and a bottom right vertex of a shelf.

The device shown in FIG. 10 can execute the shelf positioning method as provided in the embodiments shown in FIGS. 1-6, and the detailed execution process and technical effects are described in the previous embodiments, which will not be repeated here.

FIG. 11 is a structural diagram of a shelf connecting device provided by an embodiment of the present application. As shown in FIG. 11, the device comprises:
an acquisition module 91 configured to acquire image data, in an environment where the movable equipment is located, through an image acquisition module in movable equipment;
a key point detection module 92 configured to input the image data into a key point detection network to extract first position information of shelf key points in an image coordinate system from the image data through the key point detection network;
a relative pose determination module 93 configured to determine relative pose of the shelf key points relative to the movable equipment according to the first position information and a conversion relationship between the image coordinate system and a vehicle body coordinate system of the movable equipment; and
a connection module 94 configured to determine a connecting route between the movable equipment and a shelf according to the relative pose, so that the movable equipment executes a connecting process based on the connecting route.

Optionally, the device further comprises a navigation module configured to:
navigate the movable equipment to a connecting position matched with the shelf to be connected, the connecting position being a position for collecting at least one shelf key point in the environment where the movable equipment is located.

When acquiring image data, in the environment where the movable equipment is located, through an image acquisition module in movable equipment, the acquisition module 91 is specifically configured to:
photograph the image data in the environment where the movable equipment is located through the image acquisition module in the connecting position.

Optionally, the device further comprises a determination module configured to:
determine whether the shelf key points extracted by the key point detection network meet preset conditions; and
control the movable equipment to move around the shelf if the shelf key points do not meet the preset conditions;
wherein during the movement of the movable equipment, the image data in the environment where the movable equipment is located are re-acquired through the image acquisition module, and the step of extracting the first position information of the shelf key points in the image coordinate system from the image data through the key point detection network is executed until the shelf key points extracted by the key point detection network meet the preset conditions.

Optionally, the device further comprises a correction module configured to:
correct the connecting process by re-acquiring the image data in the environment where the movable equipment is located through the image acquisition module, and re-executing the step of determining the relative pose when executing the connecting process.

Optionally, when allowing the step of determining the relative pose to be re-executed to correct the connecting process, the correction module is specifically configured to:
re-execut the step of determining the relative pose to obtain a reference relative pose of the shelf key points relative to the movable equipment;
determine whether a difference between the reference relative pose and the relative pose conforms to a preset error threshold; and
if the difference does not conform to the preset error threshold, re-determining the connecting route between the movable equipment and the shelf according to the reference relative pose, so that the movable equipment corrects the connecting process based on the re-determined connecting route.

Optionally, the image acquisition module is a wide-angle monocular camera.

The device shown in FIG. 11 can execute the shelf connecting method as provided in the embodiments shown in FIGS. 7-9, and the detailed execution process and technical effects are described in the previous embodiments, which will not be repeated here.

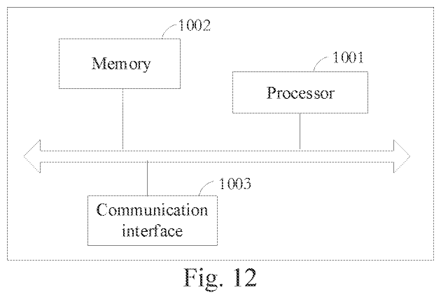

In a possible design, the device shown in FIG. 10 or FIG. 11 can be realized as electronic equipment, as shown in FIG. 12, which may comprise a processor 1001 and a memory 1002, wherein an executable code is stored on the memory 1002, and when executed by the processor 1001, the executable code causes the processor 1001 to at least realize the method as provided in the embodiments shown in FIGS. 1-9.

Optionally, the electronic equipment may further comprise a communication interface 1003 for communicating with other equipment.

In addition, an embodiment of the present application provides a non-transitory machine-readable storage medium having an executable code stored thereon, wherein when executed by a processor of electronic equipment, the executable code causes the processor to at least realize the method as provided in the embodiments shown in FIGS. 1-9.

The device embodiments described above are only for illustration. The units described as separate components may or may not be physically separated. Some or all of the modules can be selected according to actual needs to achieve the purpose of this embodiment. Those of ordinary skill in the art can understand and implement the embodiment without paying creative labor.

From the description of the above embodiments, those skilled in the art may clearly understand that each embodiment may be realized by means of necessary general hardware platforms, and of course, the embodiments may also be realized by combining hardware and software. Based on this understanding, the essence of the above technical scheme or the part that contributes to the prior art can be embodied in the form of computer products. The present application may take the form of a computer program product implemented on one or more computer usable storage media (including but not limited to magnetic disk memory, CD-ROM, optical memory, etc.) having computer usable program codes embodied therein.

The shelf positioning method provided by the embodiment of the present application can be executed by a certain program/software, which can be provided by a network side. The electronic equipment mentioned in the aforementioned embodiment can download the program/software to a local nonvolatile storage medium, and when the aforementioned shelf positioning method needs to be executed, the program/software can be read into a memory by a CPU, and then the program/software can be executed by the CPU to realize the shelf positioning method provided in the aforementioned embodiment. The execution process can be seen in FIGS. 1-6.

Finally, it should be noted that the above embodiments are only used to illustrate the technical scheme of the present application, but not to limit it. Although the present application has been described in detail with reference to the foregoing embodiments, those of ordinary skill in the art should understand that the technical scheme described in the foregoing embodiments can still be modified, or some of the technical features can be equivalently replaced, and these modifications or substitutions do not make the essence of the corresponding technical scheme deviate from the spirit and scope of the technical scheme of each embodiment of the present application.

1. A shelf positioning method, comprising:
acquiring image data, in an environment where a movable equipment is located, through an image acquisition module in the movable equipment;
inputting the image data into a key point detection network to extract first position information of shelf key points in an image coordinate system from the image data through the key point detection network; and
determining a relative pose of the shelf key points relative to the movable equipment according to the first position information and a conversion relationship between the image coordinate system and a vehicle body coordinate system of the movable equipment.

2. The method of claim 1, wherein determining a relative pose of the shelf key points relative to the movable equipment according to the first position information and a conversion relationship between the image coordinate system and a vehicle body coordinate system comprises:
calculating second position information of the shelf key points in the vehicle body coordinate system according to preset shelf parameters, camera parameters of the image acquisition module and the first position information; and
calculating the relative pose of the shelf key points relative to the movable equipment based on the conversion relationship and the second position information;
wherein the conversion relationship is obtained based on a relative position relationship between the image acquisition module and the movable equipment.

3. The method of claim 2, wherein the shelf parameters comprise shelf dimensions and the camera parameters comprise focal length parameters; and
calculating second position information of the shelf key points in the vehicle body coordinate system according to preset shelf parameters, camera parameters of the image acquisition module and the first position information comprises:
converting two-dimensional coordinates of the shelf key points in the image coordinate system into the vehicle body coordinate system according to the shelf dimensions and the focal length parameters, to obtain three-dimensional coordinates of the shelf key points in the vehicle body coordinate system.

4. The method of claim 2, wherein before calculating the relative pose of the shelf key points relative to the movable equipment based on the conversion relationship and the second position information, the method further comprises:
correcting the second position information according to inherent structural features of a shelf;
wherein the inherent structural features comprise: vertical edges of the shelf being parallel to each other, and/or horizontal edges of the shelf being parallel to each other.

5. The method of claim 1, wherein before inputting the image data into the key point detection network, the method further comprises:
performing distortion correction on coordinates of each pixel point in the image data according to focal length parameters and distortion parameters of the image acquisition module.

6. The method of claim 1, wherein the shelf key points comprise any one or more of a top left vertex, a top right vertex, a bottom left vertex and a bottom right vertex of a shelf.

7. The method of claim 1, wherein after determining a relative pose of the shelf key points relative to the movable equipment according to the first position information and a conversion relationship between the image coordinate system and a vehicle body coordinate system of the movable equipment, the method further comprises:
acquiring light detection and ranging point cloud data, in the environment where the movable equipment is located, through a light detection and ranging in the movable equipment;
post-processing coordinates of the shelf key points relative to the movable equipment; and
performing coordinate fusion on the post-processed coordinates and the light detection and ranging point cloud data to update the relative pose of the shelf key points relative to the movable equipment.

8. A shelf connecting method, comprising:
acquiring image data, in an environment where a movable equipment is located, through an image acquisition module in the movable equipment;
inputting the image data into a key point detection network to extract first position information of shelf key points in an image coordinate system from the image data through the key point detection network;
determining a relative pose of the shelf key points relative to the movable equipment according to the first position information and a conversion relationship between the image coordinate system and a vehicle body coordinate system of the movable equipment; and
determining a connecting route between the movable equipment and a shelf according to the relative pose, so that the movable equipment executes a connecting process based on the connecting route.

9. The method of claim 8, wherein after determining a relative pose of the shelf key points relative to the movable equipment according to the first position information and a conversion relationship between the image coordinate system and a vehicle body coordinate system of the movable equipment, the method further comprises:
acquiring light detection and ranging point cloud data, in the environment where the movable equipment is located, through a light detection and ranging in the movable equipment;
post-processing coordinates of the shelf key points relative to the movable equipment; and
performing coordinate fusion on the post-processed coordinates and the light detection and ranging point cloud data to update the relative pose of the shelf key points relative to the movable equipment.

10. The method of claim 8, further comprising:
navigating the movable equipment to a connecting position matched with the shelf to be connected, the connecting position being a position for collecting at least one shelf key point in the environment where the movable equipment is located;
wherein acquiring image data in the environment where a movable equipment is located through an image acquisition module in the movable equipment comprises:
photographing the image data, in the environment where the movable equipment is located, through the image acquisition module in the connecting position.

11. The method of claim, further comprising:
determining whether the shelf key points extracted by the key point detection network meet preset conditions; and
controlling the movable equipment to move around the shelf if the shelf key points do not meet the preset conditions;
wherein during movement of the movable equipment, the image data in the environment where the movable equipment is located are re-acquired through the image acquisition module, and the step of extracting the first position information of the shelf key points in the image coordinate system from the image data through the key point detection network is executed until the shelf key points extracted by the key point detection network meet the preset conditions.

12. The method of claim, further comprising:
correcting the connecting process by re-acquiring the image data in the environment where the movable equipment is located through the image acquisition module, and re-executing the step of determining the relative pose when executing the connecting process.

13. The method of claim, wherein the image acquisition module is a wide-angle monocular camera.

14. A shelf positioning device, comprising:
an acquisition module configured to acquire image data, in an environment where a movable equipment is located, through an image acquisition module in the movable equipment;
a key point detection module configured to input the image data into a key point detection network to extract first position information of shelf key points in an image coordinate system from the image data through the key point detection network; and
a relative pose determination module configured to determine a relative pose of the shelf key points relative to the movable equipment according to the first position information and a conversion relationship between the image coordinate system and a vehicle body coordinate system of the movable equipment.

15. (canceled)

16. (canceled)

17. (canceled)

18. The method of claim 9, further comprising:
navigating the movable equipment to a connecting position matched with the shelf to be connected, the connecting position being a position for collecting at least one shelf key point in the environment where the movable equipment is located;
wherein acquiring image data in the environment where a movable equipment is located through an image acquisition module in the movable equipment comprises:
photographing the image data, in the environment where the movable equipment is located, through the image acquisition module in the connecting position.

19. The method of claim 9, further comprising:
determining whether the shelf key points extracted by the key point detection network meet preset conditions; and
controlling the movable equipment to move around the shelf if the shelf key points do not meet the preset conditions;
wherein during movement of the movable equipment, the image data in the environment where the movable equipment is located are re-acquired through the image acquisition module, and the step of extracting the first position information of the shelf key points in the image coordinate system from the image data through the key point detection network is executed until the shelf key points extracted by the key point detection network meet the preset conditions.

20. The method of claim 9, further comprising:
correcting the connecting process by re-acquiring the image data in the environment where the movable equipment is located through the image acquisition module, and re-executing the step of determining the relative pose when executing the connecting process.

21. The method of claim 9, wherein the image acquisition module is a wide-angle monocular camera.
